(19) United States
(12) Patent Application Publication
(10) Pub. No.: US 2006/0024051 A1
(43) Pub. Date: Feb. 2, 2006

(54) Method and system for managing photosensitive material processor

(75) Inventor: Mitsuaki Uchida, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/185,677

(22) Filed: Jul. 21, 2005

(30) Foreign Application Priority Data
Jul. 30, 2004 (JP) 2004-224346

(51) Int. Cl. G03D 3/00

(52) U.S. Cl. 396/564

(57) ABSTRACT

A processor managing system manages a plurality of photosensitive material processors each of which includes a photosensitive material cutter. An ammeter retrieves data of a current I created while the photosensitive material cutter operates. A failure onset predicting unit predicts occurrence of a failing state of the photosensitive material cutter according to the data of the current I. The predicting unit is incorporated in a host computer. The host computer is in connection with the photosensitive material processors by the Internet. Furthermore, a storage medium stores discernment information predetermined for each photosensitive material processor, and stores information of the occurrence of the failing state at an address of the discernment information. An alarm signal is generated, which is associated with one of the photosensitive material processors in which the occurrence of the failing state is predicted according to the discernment information.

### BACKGROUND OF THE INVENTION

1. Field of the Invention

The present invention relates to a method and system for managing a photosensitive material processor. More particularly, the present invention relates to a method and system for managing a photosensitive material processor, in which plural processors can be managed reliably for maintenance by use of communication network.

2. Description Related to the Prior Art

A photosensitive material processor, for example a printer-processor composite machine for photographic prints, is installed in mini-lab as a small photo laboratory of a small photo shop or professional photofinisher. The photosensitive material processor is automated so that various processes in series can be efficiently effected for producing photographic prints, the processes including exposure of photographic paper, development, bleach/fixing, drying and sorting of prints for customer orders. The photosensitive material processor is connected by the Internet or other communication network to a host computer of a headquarter for service administered by a manufacturer of photosensitive materials. It is possible for an operator of the photosensitive material processor to report a status of the operation of the photosensitive material processor by the communication line.

There is a suggestion in JP-A 2003-075931 in which an individual computer connected with the photosensitive material processor is conditioned automatically to transmit operating information, identification information and the like to the photosensitive material processor to the host computer. This is a managing system which can be capable for coping with an error requiring urgency regarding the printing operation.

According to the method disclosed in JP-A 2003-075931 for managing the photosensitive material processor, information of an error in the photosensitive material processor is transmitted on line to the host computer upon occurrence of the error. If such an error is highly special to require exchange of rarely used parts or adjustment of complicated settings, a call for an engineer for maintenance on the manufacturer side is required. It is, however, impossible to restart the photosensitive material processor before the reach of an engineer from his or her office distant from the shop or mini-lab. Efficiency of the operation in photo finishing cannot be kept high.

### SUMMARY OF THE INVENTION

In view of the foregoing problems, an object of the present invention is to provide a method and system for managing a photosensitive material processor, in which plural processors can be managed reliably for maintenance by use of communication network.

In order to achieve the above and other objects and advantages of this invention, a processor managing method of managing an operating state of plural photosensitive material processors in connection with an external electronic instrument by a communication network is provided. In the processor managing method, time changeable data created while the photosensitive material processors operate is retrieved. A time point of occurrence of a failing state of the photosensitive material processors is predicted according to the time changeable data. Processing is provided according to a predicting result of the time point of the failing state.

Also, a processor managing system for a plurality of photosensitive material processors each of which includes at least one movable portion being operable mechanically is provided. In the processor managing system, a data retrieving unit retrieves time changeable data created while the movable portion operates. A failure onset predicting unit predicts occurrence of a failing state of the movable portion according to the time changeable data.

Furthermore, a storage medium stores discernment information predetermined for each of the photosensitive material processors, and stores information of the occurrence of the failing state at an address of the discernment information. An alarm signal generator generates an alarm signal associated with one of the photosensitive material processors in which the occurrence of the failing state is predicted according to the discernment information.

Furthermore, an external electronic instrument is in connection with the photosensitive material processors by a communication network. The predicting unit is incorporated in the external electronic instrument.

The storage medium further stores history information of the time changeable data. Furthermore, a failure factor diagnosing unit diagnoses a failure factor of the failing state according to analysis of the history information.

The failure factor diagnosing unit retrieves an amount of a time sequential change of the time changeable data from the history information, evaluates the amount of the change by comparison with a reference amount of a change, and if the amount of the change is higher than the reference amount of the change, diagnoses that the failing state is due to an abrupt damage, and if the amount of the change is equal to or lower than the reference amount of the change, diagnoses that the failing state is due to degradation with time.

Furthermore, a retrieving mode selector sets a selected one of at least first and second retrieving modes which are different from one another in a time sequence of the data retrieving unit in operation.

Furthermore, a transfer mode selector sets a selected one of at least first and second transfer modes which are different from one another in a time sequence in transmitting the time changeable data from each of the photosensitive material processors to the external electronic instrument.

Each of the photosensitive material processors has the transfer mode selector.

The at least one movable portion comprises a photosensitive material cutter for producing a photosensitive sheet by cutting continuous photosensitive material.

Each of the photosensitive material processors further includes a clock circuit for measuring time and for constituting the data retrieving unit. The time changeable data comprises operating time which elapses while the photosensitive material cutter operates.

Each of the photosensitive material processors further includes a motor for actuating the photosensitive material cutter. The data retrieving unit comprises an ammeter, and the time changeable data comprises a current value of a current for flowing in the motor while the photosensitive material cutter operates.

The failing state is predicted when the time changeable data comes up to or comes down to a predetermined critical value, according to estimating overload applied to the movable portion.

The photosensitive material is a selected one of at least first and second types, and energy required for transporting the second type is higher than energy required for transporting the first type. The storage medium further stores a plurality of the critical value predetermined differently between the at least first and second types.

Furthermore, at least one terminal device is in connection with the photosensitive material processors, responsive if the external electronic instrument is disconnected from the photosensitive material processors with the communication network, for temporarily storing the time changeable data transmitted from the photosensitive material processors.

In one preferred embodiment, furthermore, photosensitive material passed through a transporting path is photoelectrically detected. The time changeable data comprises a change in an output of the photoelectric detection.

Furthermore, photosensitive material passed through a transporting path is photoelectrically detected. The time changeable data comprises time of passage of the photosensitive material, or a length thereof, according to an output of the photoelectric detection.

The time changeable data comprises a change in voltage of a processor power source.

Furthermore, a number of times of a communication error in the communication network is counted, wherein the time changeable data comprises the number of times of the communication error.

Furthermore, the time changeable data is compared with a predetermined reference value. If a reach of the time changeable data to the predetermined reference value is detected, a period of retrieving the time changeable data is changed over to a fine mode period which is shorter than a normal period, so as to predict the occurrence of the failing state at a higher precision.

### BRIEF DESCRIPTION OF THE DRAWINGS

The above objects and advantages of the present invention will become more apparent from the following detailed description when read in connection with the accompanying drawings, in which:

FIG. 1 is an explanatory view illustrating a processor managing system;

FIG. 2 is an explanatory view in elevation, illustrating a photosensitive material processor;

FIG. 3 is a block diagram schematically illustrating an image output composite machine;

FIG. 4 is a block diagram schematically illustrating a printer in the image output composite machine;

FIG. 5 is a graph illustrating a relationship between a current to flow in a motor and elapsed time;

FIG. 6 is a block diagram schematically illustrating a host computer; and

FIG. 7 is a flow chart illustrating operation of a processor managing in the processor managing system.

### DETAILED DESCRIPTION OF THE PREFERRED EMBODIMENT(S) OF THE PRESENT INVENTION

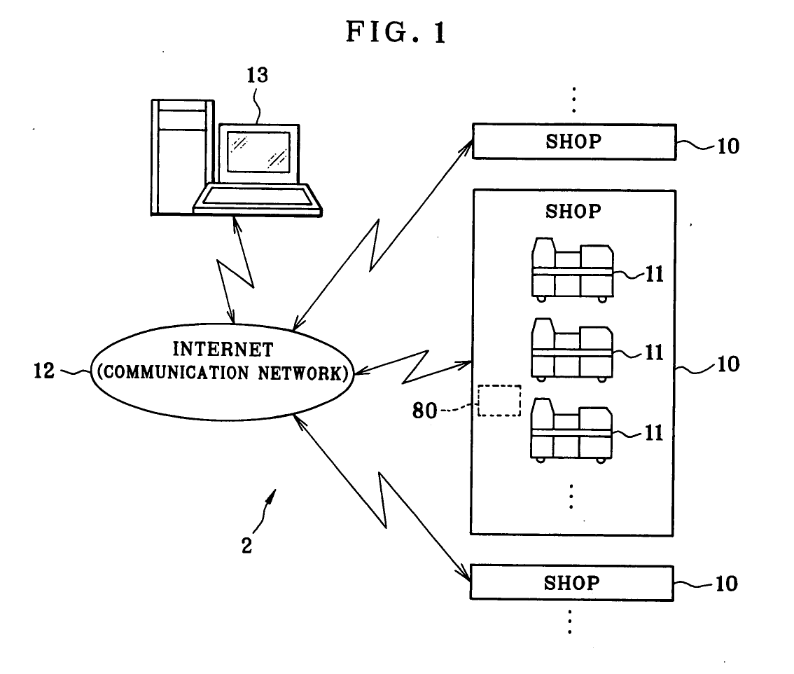

In FIG. 1, a processor managing system 2 is illustrated. A shop 10, for example a shop of a photofinishing agent or a photo laboratory for photofinishing, is provided with a plurality of. photosensitive material processors 11. A host computer (HC) 13 as external electronic instrument is connected with the photosensitive material processors 11 by means of the Internet 12 as communication network, for monitoring and managing an operating status of the photosensitive material processors 11.

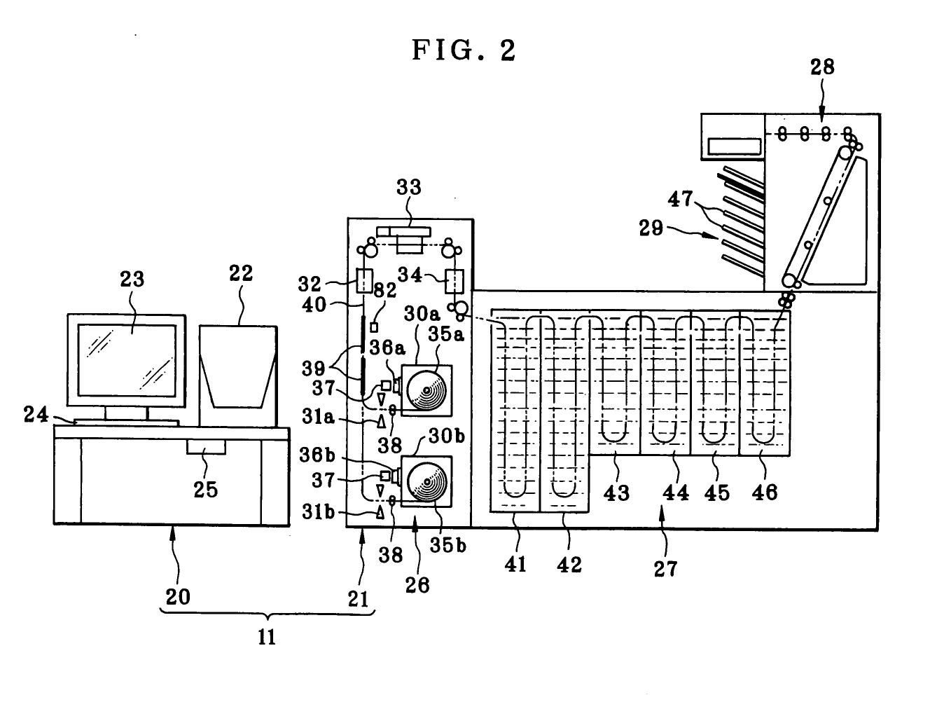

In FIG. 2, each of the photosensitive material processors 11 includes a data input composite machine 20 and an image output composite machine 21. The data input composite machine 20 is constituted by an image reader 22, a display panel 23 as user interface, an input keypad 24 and an image input terminal or card slot 25. The image reader 22 scans and reads images from developed photo film to generate image data of a digital form. The display panel 23 displays image of the image data. The input keypad 24 is manually operable, and inputs signals for selection, editing and the like of image data. The image input terminal 25 is an input connectable with a digital camera or memory card for inputting image data obtained by image pickup.

The image output composite machine 21 is constituted by an image forming device or printer 26, a processing bath group 27, a drier 28 and a sorter/stacker 29. In the printer 26, magazines 30a and 30b are loaded. The printer 26 includes photosensitive material cutters 31a and 31b, a back imprinting unit 32, an exposure printhead 33 and a sheet distributor 34.

Rolls of photosensitive materials 35a and 35b are accommodated in respectively the magazines 30a and 30b, and are types different from one another. A difference between the photosensitive materials 35a and 35b lie at least one of a material width, material surface quality and the like. Bar code stickers 36a and 36b are attached to the magazines 30a and 30b, and have particular information of the photosensitive materials 35a and 35b, for example, material types, a date of manufacture, and the like. A bar code reader 37 is disposed near to the magazines 30a and 30b, and reads the information from the bar code stickers 36a and 36b.

An advancing roller 38 is disposed at an outlet of the magazines 30a and 30b for advancing the photosensitive materials 35a and 35b. To unwind and advance the photosensitive materials 35a and 35b, the advancing roller 38 is controlled for rotation at an amount according to size information of an image of data transmitted by the data input composite machine 20.

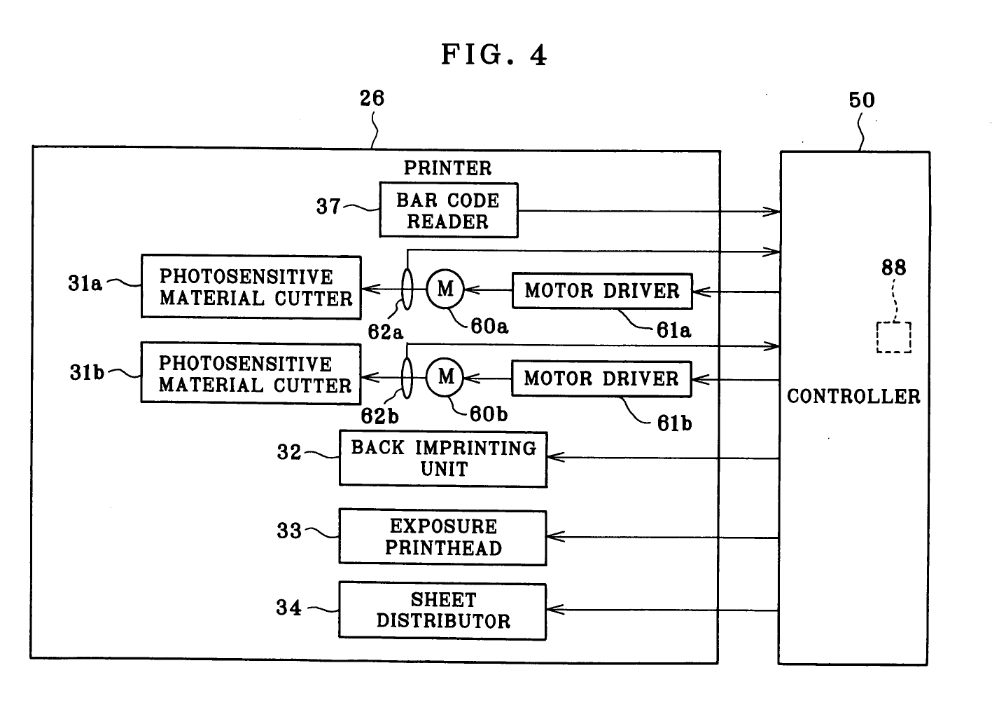

The photosensitive material cutters 31a and 31b are a type of a rotary cutter. Motors 60a and 60b of FIG. 4 drive the photosensitive material cutters 31a and 31b, which cut the photosensitive materials 35a and 35b from the magazines 30a and 30b at a predetermined length. So photosensitive sheets 39 of a limited length are formed. A transporting path 40 is indicated by the phantom lines in the drawing. The photosensitive sheets 39 are transported along the transporting path 40.

The back imprinting unit 32 imprints various alphanumerical information to a back surface of the photosensitive sheets 39, the information including a customer number, serial numbers of images, and the like. The exposure printhead 33 creates an image on the photosensitive sheets 39 by exposure with laser light according to image data input by the data input composite machine 20. The sheet distributor 34 distributes a number of the photosensitive sheets 39 being exposed into the processing bath group 27 in an aligned manner of two lines.

The processing bath group 27 includes a developing bath 41, a bleach/fixing bath 42, and first, second, third and fourth water washing baths 43, 44, 45 and 46. The developing bath 41 contains developing solution. The bleach/fixing bath 42 contains bleach/fixing solution. Each of the water washing baths 43-46 contains washing water. The photosensitive sheets 39 are passed through the baths 41-46 in series, and subjected to development, bleach/fixing and water washing.

The drier 28 dries the photosensitive sheets 39 being washed with water. Sorting panels 47 are provided in the sorter/stacker 29. The sorter/stacker 29 sorts the photosensitive sheets 39 per customer orders after the drying operation, and stacks the photosensitive sheets 39 in a sorted form.

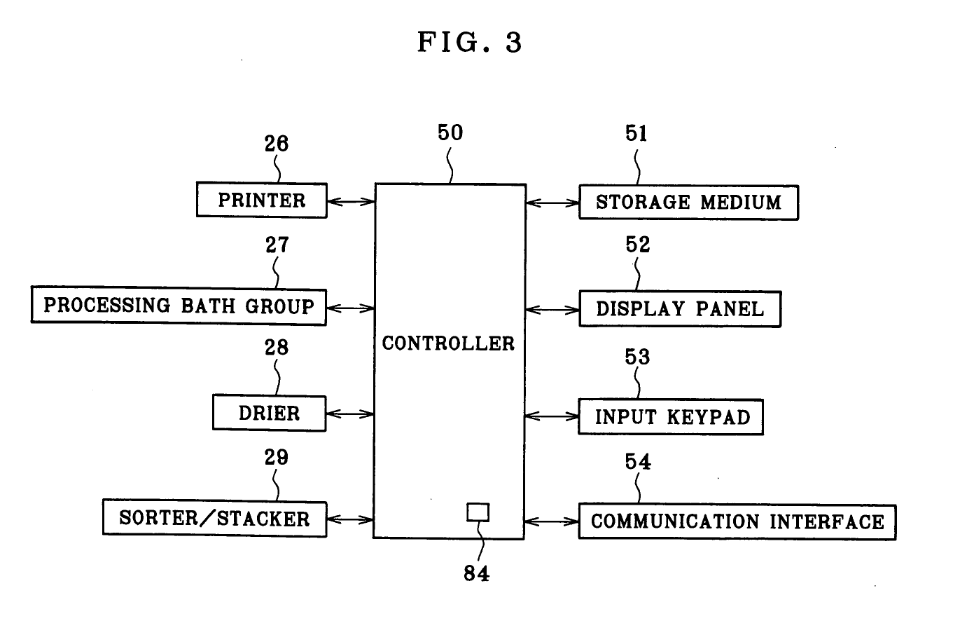

In FIG. 3, circuitry in the image output composite machine 21 is illustrated. A controller 50 comprehensively controls relevant elements in the image output composite machine 21. With the controller 50, a storage medium or memory 51, a display panel 52 as user interface, an input keypad 53 as a transfer mode selector and retrieving mode selector, and a communication interface 54 are connected.

The storage medium 51 stores various data and programs executable for actuating the image output composite machine 21. Also, information is written to the storage medium 51, including image data obtained by the data input composite machine 20, personal information of customers, and time changeable data which will be described in detail. The display panel 52 displays various kinds of information according to the operating status of the image output composite machine 21. Also, discernment information of each photosensitive material processor 11 is stored in storage medium 51.

The input keypad 53 is pushed or operated manually for purposes of changing a setting or mode of the image output composite machine 21 or the like. The controller 50 is responsive to the status of the input keypad 53, and causes the elements of the image output composite machine 21 to operate. The communication interface 54 is used for reception and transmission of data in connection with the data input composite machine 20 and the host computer 13 via the Internet 12 as network.

In FIG. 4, the photosensitive material cutters 31a and 31b in the printer 26 are driven by the motors 60a and 60b. Motor drivers 61a and 61b are caused by the controller 50 to drive the motors 60a and 60b which are DC motors. A clock circuit 88 in the controller 50 measures time.

Ammeters or current measurers 62a and 62b as data retrieving units are connected electrically with the motors 60a and 60b at respectively the photosensitive material cutters 31a and 31b. The ammeter 62a, while the motor 60a causes the photosensitive material cutter 31a to move, measures a current before the photosensitive material cutter 31a cuts the photosensitive material 35a and moves backwards. Similarly, the ammeter 62b, while the motor 60bcauses the photosensitive material cutter 31b to move, measures a current before the photosensitive material cutter 31b cuts the photosensitive material 35b and moves backwards. The ammeters 62a and 62b respectively send a signal of detection results to the controller 50.

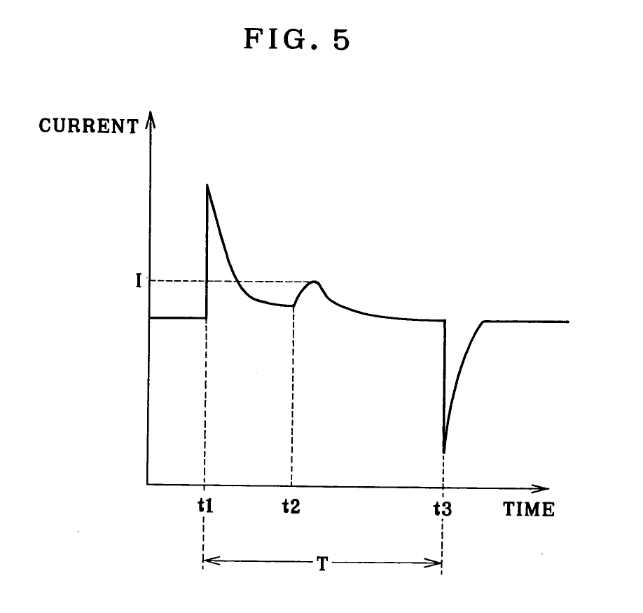

A graph of FIG. 5 is obtained regarding changes of the current with time according to measuring results of the current at the ammeters 62a and 62b. At the time t1 of the startup of the photosensitive material cutters 31a and 31b, a value of the current is higher because of a rush current of the motors 60a and 60b. The level of the current gradually decreases after the time t1 of the startup. At the time t2 of the onset of cutting of the photosensitive materials 35a and 35b, a value of the current increases up to the current I because of resistance of the photosensitive materials 35a and 35b. Upon the completion of the cutting, the current decreases again. At the time t3 of the stop of the photosensitive material cutters 31a and 31b, a current flows in a direction reverse to that at the time t1 of the startup, to move back the photosensitive material cutters 31a and 31b to their initial positions.

The controller 50 writes information of the current I to the storage medium 51, and also writes the time T elapsed from the time t1 of the startup of the photosensitive material cutters 31a and 31b to the time t3 of the stop. The information of the current I and time T is the time changeable data. There are a plurality of selectable retrieving modes regarding retrieval of the information of the time T and current I from the ammeters 62a and 62b. A first of the retrieving modes is retrieval immediately after turning on the power of the photosensitive material processor 11 for test printing. A second of the retrieving modes is regularly periodical retrieval during idle time where no printing job exists. A third of the retrieving modes is retrieval upon a start of printing. A fourth of the retrieving modes is retrieval in response to a command signal input by the host computer 13 or manually by an operator of the photosensitive material processor 11.

There are a plurality of selectable transfer modes regarding transmission of the information of the current I and time T to the host computer 13. A first of the transfer modes is transmission immediately after turning on the power of each of the photosensitive material processors 11. A second of the transfer modes is regularly periodical transmission at a lapse of predetermined time. A third of the transfer modes is transmission in response to a command signal input by the host computer 13 or manually by an operator. Note that the input keypad 53 as a transfer mode selector is used for selectively setting one of the modes of the transmission of the time changeable data and the modes of the retrieval of the time changeable data.

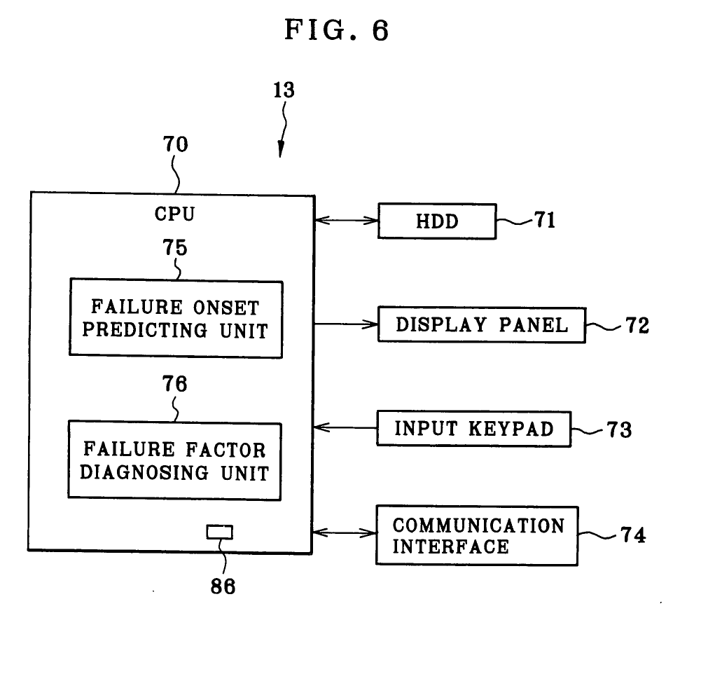

In FIG. 6, a CPU 70 controls the entirety of the circuits and the like in the host computer 13. Relevant elements are connected with the CPU 70, including a hard disk (HDD) 71 or storage medium, a display panel 72 as user interface, an input keypad 73 as a transfer mode selector, and a communication interface 74. This is similar to the controller 50 of the image output composite machine 21.

The CPU 70 includes an abnormality or failure onset predicting unit 75 and an abnormality or failure factor diagnosing unit 76. The failure onset predicting unit 75 predicts estimated time of occurrence of a breakage, abnormality, malfunction, problem or other failures according to the time changeable data generated by the image output composite machine 21.

In general, the time T and current I measured by use of the ammeters 62a and 62b are different between types of the photosensitive materials 35a and 35b, specifically according to their thickness, material width, surface quality and the like. The current I and time T are greater according to the greatness of the thickness and width. The same occurs also when degradation occurs in the photosensitive material cutters 31a and 31b, for example, rust of metal, dullness of the blade, and the like. The failure onset predicting unit 75 predicts the period of occurrence of failure by utilizing of the phenomena of higher resistance. Specifically, it is judged that performance of the photosensitive material cutters 31a and 31b has reached a lower limit sufficient for good quality when at least one of the current I and time T becomes equal to or more than an upper critical value. It is to be noted that an alternative critical value may be determined with a different meaning. The current I and time T can be monitored during a period of a regular length, and checked if raised over the alternative critical value. The rise can be counted by a counter to obtain the number of times of peaking. The number of times can be evaluated in comparison with a critical number, so as to predict the period of occurrence of a failure.

If the failure onset predicting unit 75 judges that the remainder of the life of the photosensitive material cutters 31a and 31b is short, then the host computer 13 generates and sends information of a message to a specified one of the photosensitive material processors 11 through the communication interface 74. Examples of such messages are: Term of the cutter will expire soon; Exchange the cutter within 1 month; The cutter must be inspected for abnormality. The specified photosensitive material processor 11 causes the display panel 52 of the image output composite machine 21 to display the message received from the host computer 13, and provides an operator of the specified photosensitive material processor 11 with the information.

A data table is stored in the hard disk 71, and consists of information of types of photosensitive materials, and critical values adapted to diagnosing a state of the photosensitive material cutters 31a and 31b approximately critical as to keep the cutting performance, the critical values being associated with respectively the type information. The CPU 70 receives the type information of the photosensitive materials 35a and 35b according to a result of reading of the bar code reader 37 in the image output composite machine 21, and refers to the data table to find a critical value particularly related to the type information. Then the CPU 70 transmits the information of the critical value to the failure onset predicting unit 75. The failure onset predicting unit 75 predicts the onset of a failure as described above by comparing the critical value with the time T and current I measured by the ammeters 62a and 62b.

The failure factor diagnosing unit 76 determines a factor of the failure according to the history information of the time changeable data. Specifically, the failure factor diagnosing unit 76, if there is a slow increase in the current I and time T until a reach to an upper critical value, determines that a factor of the failure is degradation with time. The failure factor diagnosing unit 76, if there is an abrupt increase in the current I and time T until a reach to the upper critical value, determines that a factor of the failure is damage in an accidental manner. The failure factor diagnosing unit 76 writes information of this diagnostic result to the hard disk 71 together with the time changeable data. For the diagnostic result, the discernment information of each of the photosensitive material processors 11 is used as address in the data in the hard disk 71.

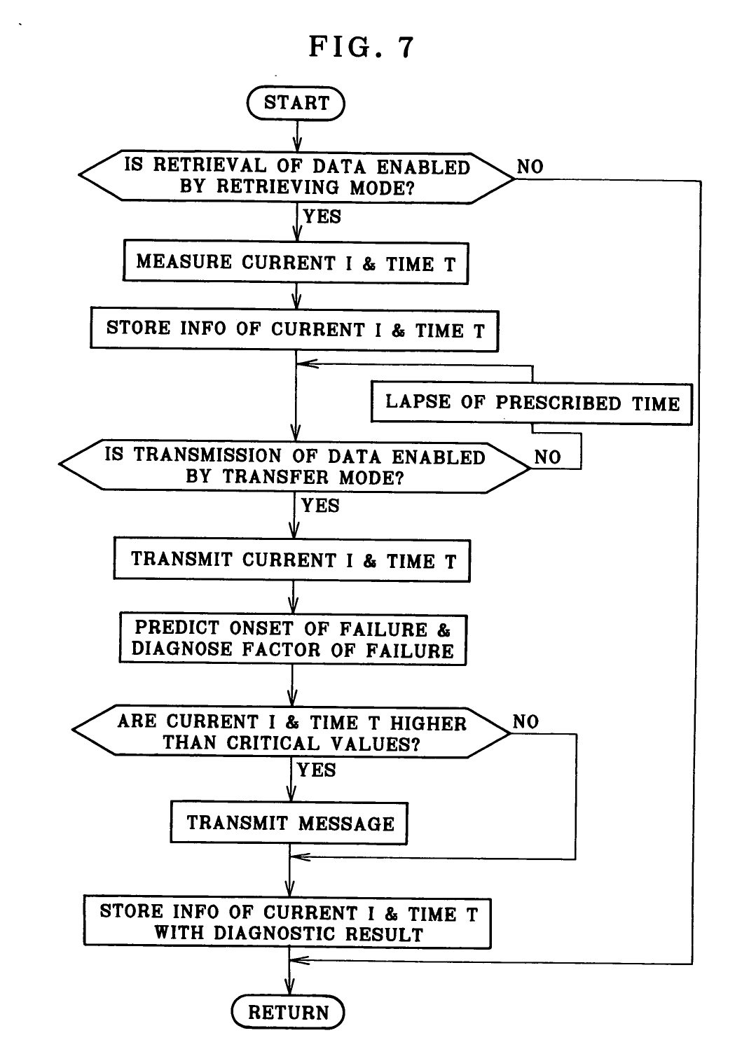

The operation of the above construction is described now by referring to FIG. 7. In one of the photosensitive material processors 11, at first, the image reader 22 or the image input terminal 25 of the data input composite machine 20 retrieves image data of an image to be printed. The image data is transmitted by the communication interface 54 to the image output composite machine 21, and written to the storage medium 51.

After retrieving the image data, a command signal for printing is input. The advancing roller 38 is caused to rotate to unwind the photosensitive materials 35a and 35b from the magazines 30a and 30b. The photosensitive material cutter 31a cuts the photosensitive sheets 39 from the photosensitive material 35a extending from the magazine 30a at a predetermined length. Similarly, the photosensitive material cutter 31b cuts the photosensitive sheets 39 from the photosensitive material 35b extending from the magazine 30b.

If retrieval of time changeable data is previously designated by a setting at the input keypad 53, then a current I and time T are measured and obtained by measurement of the ammeters 62a and 62b. Information of the current I and time T is transmitted to the controller 50, and written to the storage medium 51. If no retrieval of time changeable data is designated by a setting at the input keypad 53, then there is no measurement of a current I and time T.

Information of the current I and time T is read from the storage medium 51, and transmitted to the host computer 13 through the communication interface 54 and the Internet 12 as network according to timing set by operating the input keypad 53 as a retrieving mode selector. In the host computer 13, the failure onset predicting unit 75 estimates time of occurrence of a failure in the specified photosensitive material processor 11 according to the time changeable data received from the image output composite machine 21. Also, the failure factor diagnosing unit 76 analyzes and estimates a factor of the failure according to history information of the time changeable data. Note that a timer is utilized for periodical check of timing of transmission of information of the current I and time T.

If the failure onset predicting unit 75 judges that the remainder of the life of the photosensitive material cutters 31a and 31b is shorter than a reference value due to a reach of the current I and time T to the critical value, then massage information of a message is transmitted by the communication interface 74 to the specified photosensitive material processor 11. In the photosensitive material processor 11, a message of the message information received from the host computer 13 is displayed on the display panel 52 of the image output composite machine 21, to inform an operator of the present status at the photosensitive material processor 11. If the current I and time T have not come up to the critical value, then the photosensitive material cutters 31a and 31bare regarded as normal in operation. No message is transmitted.

The information of the current I and time T is stored in the hard disk 71 as history information of the time changeable data after the prediction of the period of occurrence of a failure and the analysis of the factor of the failure. If the failure onset predicting unit 75 judges shortness of the remaining life of the photosensitive material cutters 31a and 31b, the diagnostic result in the failure factor diagnosing unit 76 is also written to the hard disk 71.

Each photosensitive sheet 39 formed at the regular length by the photosensitive material cutters 31a and 31bis transported through the transporting path 40, and subjected to back imprinting by the back imprinting unit 32 for alphanumerical information. The exposure printhead 33 prints an image by exposure to the photosensitive sheet 39 according to image data. Then the sheet distributor 34 distributes the photosensitive sheet 39 in two lines for transport into the processing bath group 27.

The photosensitive sheet 39 entered in the processing bath group 27 is passed through the developing bath 41, the bleach/fixing bath 42, and the water washing baths 43-46 in sequence, and developed, bleached and fixed, and washed with water. The photosensitive sheet 39 after washing is dried by the drier 28, and sorted by the sorter/stacker 29 for each of customer orders, for being stacked on the sorting panels 47.

As described heretofore, the ammeters 62a and 62b are used to measure the time changeable data which include the time T of operation of the photosensitive material cutters 31a and 31b, and the current I of the motors 60a and 60bfor driving the photosensitive material cutters 31a and 31b. A period of onset of a failure is predicted by the failure onset predicting unit 75, to generate a message according to the prediction. Therefore, it is possible to keep the operation reliable readily before occurrence of a failure. Thus, efficiency of operation of the photosensitive material processors 11 can be kept high without drop. Furthermore, calls of engineers or repairers of maintenance for inspection and repair can be less frequent, so expense required for the personnel to manage the photosensitive material processors 11 can be reduced.

Furthermore, reasons of the failure are diagnosed by the failure factor diagnosing unit 76 according to the history information of the time changeable data. The diagnostic result is written to the hard disk 71. So the teachings of the failure can be reflected to future design of machines and countermeasures for future failures.

Also, the selective modes related to time points for retrieval of time changeable data and transmission of time changeable data are provided. It is possible to determine a setting desired by an operator of the photosensitive material processors 11.

In the above embodiment, the examples of the time changeable data are operating time T of the photosensitive material cutters 31a and 31b, and the current I for flow in the motors 60a and 60b to drive the photosensitive material cutters 31a and 31b. However, time changeable data according to the invention can be other values. Various examples of time changeable data may be used, which include: an output level of a sheet sensor 82, for example photo interrupter as photo sensor, for detecting passage of the photosensitive sheets 39 in the transporting path 40, passage time and a length of the photosensitive sheets 39 detected by the sheet sensor 82, changes in voltage in a power source for powering each photosensitive material processor 11, an output level of laser in the exposure printhead 33, density of solution in the baths 41-46 of the processing bath group 27, operating time of a temperature adjusting heater provided on the water washing baths 43-46, time of rotation of a pump for replenishment of water to the water washing baths 43-46, amounts of data written to or read from the storage medium 51, and the number of times of failures in transmission of the communication interface 54 according to a count of a counter 84. Also, density of a test print may be used as time changeable data, as disclosed in U.S. Pat. No. 5,291,420 (corresponding to JP-A 3-241349).

It is possible to use image data as time changeable data, for example, a tilted state of the photosensitive sheet 39 traveling through the transporting path 40 according to image data of the photosensitive sheet 39 picked up by an image area sensor or CCD. This is disclosed in U.S. Pat. No. 6,831,665 (corresponding to JP-A 2002-082399). It is preferable to compress image data in a suitable file format of compression so as to make a full use of capacity of the storage medium 51 for storage.

Note that it is likely that the host computer 13 is disconnected from the photosensitive material processors 11 in the communication. No transmission of the time changeable data is successful. For such a situation, a personal computer or terminal device 80 is preferably used as a provisional storage before renewal of communication with the host computer 13. The terminal device 80 is installed in the shop 10, and used for storing time changeable data generated by the particular photosensitive material processors 11.

Also, critical values and message information can be modified and customized according to a size of the shop 10. For example, there is environment where efficiency of the total of a considerably large system in operation may be not influenced by a failure in only one of the photosensitive material processors 11. It is possible to predetermine a critical value with larger allowance in particular. Examples of such environment is a shop having a specifically great number of the photosensitive material processors 11, a shop located particularly near to a service center where engineers or repairers are ready, or the like. Each critical value for the time T and current I can be higher than a normal critical value.

On the contrary, a critical value can be predetermined with smaller allowance, in environment, for example, a shop having a small number of the photosensitive material processors 11, a shop located particularly distant from a service center where engineers or repairers are ready.

Furthermore, it is possible in the failure onset predicting unit 75 to determine one portion in one of the photosensitive material processors 11 specifically where a failure or error occurs. The host computer 13, responsive to prediction of the occurrence of a failure in the failure onset predicting unit 75, can send a signal to an order processor for automatically placing an order of new parts for the portion with the failure. This is effective in reducing requirement for calling operators or repairers to repair the photosensitive material processors 11 by manual handling.

Furthermore, it is possible to preset two retrieving modes of retrieving time changeable data, namely a normal mode and a fine mode in which retrieval is repeated at a shorter period than the normal mode. A comparator 86 is used for comparing the time changeable data with a reference value near to the critical value. The CPU 70 is responsive to detecting a reach of the time changeable data to the reference value, and changes over a period of retrieval of the time changeable data to a fine mode period which is shorter than a normal period, so as to predict occurrence of a failing state with high precision. This is favorable to higher precision in both the prediction and diagnosis of failures.

Furthermore, the failure onset predicting unit 75 and the failure factor diagnosing unit 76 may be incorporated in each of the photosensitive material processors 11 instead of being incorporated in the host computer 13.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

What is claimed is:

1. A processor managing method of managing an operating state of plural photosensitive material processors in connection with an external electronic instrument by a communication network, said processor managing method comprising steps of:
retrieving time changeable data created while said photosensitive material processors operate;
predicting a time point of occurrence of a failing state of said photosensitive material processors according to said time changeable data; and
processing according to a predicting result of said time point of said failing state.

2. A processor managing method as defined in claim 1, wherein each of said photosensitive material processors includes at least one movable portion being operable mechanically;
wherein said time changeable data is created while said movable portion operates.

3. A processor managing method as defined in claim 2, wherein discernment information is predetermined in association with each of said photosensitive material processors;
information of said time point of said failing state is stored at an address of said discernment information;
said processing step includes generating an alarm signal associated with one of said photosensitive material processors in which said occurrence of said failing state is predicted according to said discernment information.

4. A processor managing method as defined in claim 3, further comprising a step of diagnosing a failure factor of said failing state according to analysis of history information of said time changeable data.

5. A processor managing method as defined in claim 4, wherein said diagnosing step includes:
retrieving an amount of a time sequential change of said time changeable data from said history information;
evaluating said amount of said change by comparison with a reference amount of a change;
if said amount of said change is higher than said reference amount of said change, diagnosing that said failing state is due to an abrupt damage; and
if said amount of said change is equal to or lower than said reference amount of said change, diagnosing that said failing state is due to degradation with time.

6. A processor managing method as defined in claim 3, further comprising a step of setting a selected one of at least first and second retrieving modes which are different from one another in a time sequence of retrieval of said time changeable data.

7. A processor managing method as defined in claim 3, wherein each of said photosensitive material processors transmits said time changeable data to said external electronic instrument by said communication network;
further comprising a step of setting a selected one of at least first and second transfer modes which are different from one another in a time sequence in transmitting said time changeable data.

8. A processor managing method as defined in claim 3, wherein said at least one movable portion comprises a photosensitive material cutter for producing a photosensitive sheet by cutting continuous photosensitive material.

9. A processor managing method as defined in claim 8, wherein said time changeable data comprises operating time, and is measured while said photosensitive material cutter operates.

10. A processor managing method as defined in claim 8, wherein each of said photosensitive material processors further includes a motor for actuating said photosensitive material cutter;
said time changeable data comprises a current value of a current for flowing in said motor while said photosensitive material cutter operates.

11. A processor managing method as defined in claim 8, wherein said failing state is predicted when said time changeable data comes up to or comes down to a predetermined critical value, according to estimating overload applied to said movable portion.

12. A processor managing method as defined in claim 11, wherein said photosensitive material is a selected one of at least first and second types, and energy required for transporting said second type is higher than energy required for transporting said first type;
said critical value is predetermined differently between said at least first and second types.

13. A processor managing method as defined in claim 8, further comprising a step of photoelectrically detecting said photosensitive material passed through a transporting path;
wherein said time changeable data comprises a change in an output of said photoelectric detection.

14. A processor managing method as defined in claim 8, further comprising a step of photoelectrically detecting said photosensitive material passed through a transporting path;
wherein said time changeable data comprises time of passage of said photosensitive material, or a length thereof, according to an output of said photoelectric detection.

15. A processor managing method as defined in claim 3, wherein said time changeable data comprises a change in voltage of a processor power source.

16. A processor managing method as defined in claim 3, further comprising a step of counting a number of times of a communication error in said communication network;
wherein said time changeable data comprises said number of times of said communication error.

17. A processor managing method as defined in claim 3, further comprising steps of:
comparing said time changeable data with a predetermined reference value; and
if a reach of said time changeable data to said predetermined reference value is detected, changing over a period of retrieving said time changeable data to a fine mode period which is shorter than a normal period, so as to predict said occurrence of said failing state at a higher precision.

18. A processor managing system for a plurality of photosensitive material processors each of which includes at least one movable portion being operable mechanically, said processor managing system comprising:
a data retrieving unit for retrieving time changeable data created while said movable portion operates; and
a failure onset predicting unit for predicting occurrence of a failing state of said movable portion according to said time changeable data.

19. A processor managing system as defined in claim 18, further comprising:
a storage medium for storing discernment information predetermined for each of said photosensitive material processors, and storing information of said occurrence of said failing state at an address of said discernment information;
an alarm signal generator for generating an alarm signal associated with one of said photosensitive material processors in which said occurrence of said failing state is predicted according to said discernment information.

20. A processor managing system as defined in claim 19, further comprising an external electronic instrument in connection with said photosensitive material processors by a communication network;
wherein said predicting unit is incorporated in said external electronic instrument.

21. A processor managing method as defined in claim 20, wherein said storage medium further stores history information of said time changeable data;
further comprising a failure factor diagnosing unit for diagnosing a failure factor of said failing state according to analysis of said history information.

22. A processor managing system as defined in claim 21, wherein said failure factor diagnosing unit retrieves an amount of a time sequential change of said time changeable data from said history information, evaluates said amount of said change by comparison with a reference amount of a change, and if said amount of said change is higher than said reference amount of said change, diagnoses that said failing state is due to an abrupt damage, and if said amount of said change is equal to or lower than said reference amount of said change, diagnoses that said failing state is due to degradation with time.

23. A processor managing system as defined in claim 20, further comprising a retrieving mode selector for setting a selected one of at least first and second retrieving modes which are different from one another in a time sequence of said data retrieving unit in operation.

24. A processor managing system as defined in claim 20, further comprising a transfer mode selector for setting a selected one of at least first and second transfer modes which are different from one another in a time sequence in transmitting said time changeable data from each of said photosensitive material processors to said external electronic instrument.

25. A processor managing system as defined in claim 24, wherein each of said photosensitive material processors has said transfer mode selector.

26. A processor managing system as defined in claim 20, wherein said at least one movable portion comprises a photosensitive material cutter for producing a photosensitive sheet by cutting continuous photosensitive material.

27. A processor managing system as defined in claim 26, wherein each of said photosensitive material processors further includes a clock circuit for measuring time and for constituting said data retrieving unit;
said time changeable data comprises operating time which elapses while said photosensitive material cutter operates.

28. A processor managing system as defined in claim 26, wherein each of said photosensitive material processors further includes a motor for actuating said photosensitive material cutter;
said data retrieving unit comprises an ammeter, and said time changeable data comprises a current value of a current for flowing in said motor while said photosensitive material cutter operates.

29. A processor managing system as defined in claim 26, wherein said failing state is predicted when said time changeable data comes up to or comes down to a predetermined critical value, according to estimating overload applied to said movable portion.

30. A processor managing system as defined in claim 29, wherein said photosensitive material is a selected one of at least first and second types, and energy required for transporting said second type is higher than energy required for transporting said first type;
said storage medium further stores a plurality of said critical value predetermined differently between said at least first and second types.

31. A processor managing system as defined in claim 20, further comprising at least one terminal device, in connection with said photosensitive material processors, and responsive if said external electronic instrument is disconnected from said photosensitive material processors with said communication network, for temporarily storing said time changeable data transmitted from said photosensitive material processors.
